(19) United States
(12) Patent Application Publication
(10) Pub. No.: US 2017/0353133 A1
(43) Pub. Date: Dec. 7, 2017

(54) DEVICE AND METHOD FOR SENSING A ROTATIONAL POSITION OF A ROTATABLE ELEMENT, CONTROLLER, SENSOR SYSTEM FOR DETECTING A ROTATIONAL POSITION OF A ROTATABLE ELEMENT, AND HOUSEHOLD APPLIANCE

(71) Applicant: Miele & Cie. KG, Guetersloh (DE)

(72) Inventors: Maximilian Exner, Guetersloh (DE); Frank Evertzberg, Marienfeld (DE); Florian Schacht, Guetersloh (DE); Johann Banmann, Guetersloh (DE)

(21) Appl. No.: 15/607,538

(22) Filed: May 29, 2017

(30) Foreign Application Priority Data
Jun. 1, 2016 (DE) 10 2016 110 085.4

(51) Int. Cl. H02P 8/08; H02P 21/12; H02P 6/15; D06F 58/28; D06F 33/02

(52) U.S. Cl. CPC H02P 8/08; H02P 21/12; H02P 6/157; D06F 33/02; D06F 58/28

(57) ABSTRACT

A device for sensing a rotational position of a rotatable element for a household appliance includes: a stator having a plurality of capacitive sensor surfaces spaced apart from one another in a plane of extension of the stator; and a rotor rotatably positionable or disposed relative to the stator and having an electrically conductive section and a dielectric non-conductive section, the conductive section being larger in area than the non-conductive section, the rotor being disposed opposite the plane of extension of the stator in a rotatable condition relative to the stator, and the rotor being couplable or coupled to the rotatable element.

### CROSS-REFERENCE TO PRIOR APPLICATION

Priority is claimed to German Patent Application No. DE 10 2016 110 085.4, filed on Jun. 1, 2016, the entire disclosure of which is hereby incorporated by reference herein.

### FIELD

The present invention relates to a device for sensing a rotational position of a rotatable element, a method for determining a rotational position of a rotatable element, a corresponding controller, a sensor system for detecting a rotational position of a rotatable element, and a household appliance.

### BACKGROUND

In different product ranges of household appliances, for example, cycle selection and menu navigation may be performed using electromechanical rotary selector switches. Depending on the appliance, incremental or absolute evaluation methods may be used. Rotational movement may be transmitted from the rotary selector switch, for example, through a supported shaft, to a detent mechanism and electronic components for evaluating rotational angles on operating and display electronics. Evaluation of the rotary position on the operating and display electronics may take place, in particular, behind a fascia panel.

German Patent Application DE 10 2009 002 623 A1 discloses a program selector for home appliance having a capacitive touch or proximity sensor device.

### SUMMARY

In an embodiment, the present invention provides a device for sensing a rotational position of a rotatable element for a household appliance, the device comprising: a stator having a plurality of capacitive sensor surfaces spaced apart from one another in a plane of extension of the stator; and a rotor rotatably positionable or disposed relative to the stator and having an electrically conductive section and a dielectric non-conductive section, the conductive section being larger in area than the non-conductive section, the rotor being disposed opposite the plane of extension of the stator in a rotatable condition relative to the stator, and the rotor being couplable or coupled to the rotatable element.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a household appliance according to an exemplary embodiment of the present invention;

FIG. 2 is a schematic view of a sensor system according to an exemplary embodiment of the present invention;

FIG. 3 is a schematic view of a stator of a device according to an exemplary embodiment of the present invention;

FIG. 4 is a schematic view of a rotor of a device according to an exemplary embodiment of the present invention;

FIG. 5 is a schematic top view showing a stator and a rotor superimposed thereon according to an exemplary embodiment of the present invention;

FIG. 6 is a flow chart of a determination method according to an exemplary embodiment of the present invention;

FIG. 7 is a flow chart of a position determination process according to an exemplary embodiment of the present invention;

FIG. 8 is a schematic signal waveform diagram according to an exemplary embodiment of the present invention;

FIG. 9 is a schematic signal waveform diagram according to an exemplary embodiment of the present invention; and

FIG. 10 is a schematic signal waveform diagram according to an exemplary embodiment of the present invention.

### DETAILED DESCRIPTION

In an embodiment, the present invention provides a device for sensing a rotational position of a rotatable element, a method for determining a rotational position of a rotatable element, a corresponding controller, a sensor system for detecting a rotational position of a rotatable element, a household appliance and computer program product having the features of the main claims.

In addition to a cost-effective and space-saving design, another particular advantage achievable by the present invention is that it can provide a measuring method for capacitance-based contactless and absolute determination of rotational angles. By dispensing with a ground surface for a stator, there is no need, in particular, to route a wire from such a ground surface at a distance to sensor surfaces of the stator, so that the determination of the rotational position can be performed in a space-saving, cost-effective and uncomplicated manner and, through omission of a ground surface, with an increased sensor surface. Since the ground surface is dispensed with, no interference effects can occur in a supply line to such a ground surface. A surface area that would otherwise be needed for the ground surface can be distributed among the sensor surfaces, thereby making it possible to increase a surface area of each of the sensor surfaces, which in turn makes it possible to obtain a larger raw value as a measured parameter. Thus, it is possible not only to dispense with a wire that would have to be routed in a complex fashion to an otherwise provided ground surface, but to determine the rotational position or rotational angle capacitively, absolutely and reliably, even after a restart or system restart.

Presented is a device for sensing a rotational position of a rotatable element, the device including the following features:

a stator having a plurality of capacitive sensor surfaces spaced apart from one another in a plane of extension of the stator; and

a rotor rotatably positionable or disposed relative to the stator and having an electrically conductive section and a dielectric non-conductive section, the conductive section preferably being larger in area than the non-conductive section, the rotor being disposed opposite the plane of extension of the stator in a rotatable condition relative to the stator, and the rotor being couplable or coupled to the rotatable element.

The rotatable element may be a control element, in particular a rotary selector switch, for controlling at least one function of an appliance. The sensor surfaces may extend along the plane of extension of the stator. The non-conductive section may have a dielectric solid, a gap, air gap or an interstice. The conductive section of the rotor is configured to cover or overlap at least one sensor surface when the rotor is in a rotatable condition relative to the stator. In particular, in the rotatable condition relative to the stator, the conductive section of the rotor may be disposed opposite the plane of extension of the stator. The stator may have at least two sensor surfaces, at least three sensor surfaces, or more than three sensor surfaces.

In the context of the present invention, the terms “covering” and “overlapping” are meant to refer to a mutually spaced-apart, so that the rotor and the stator do not conductively contact each other, but are spaced apart by a dielectric, and that the projection of the rotor in a direction perpendicular to its direction of rotation at least partially covers or overlaps the stator. The dielectric may be air, plastic, glass or another suitable material.

In accordance with an embodiment, the sensor surfaces may be configured and, additionally or alternatively, arranged to intermesh with each other in the plane of extension of the stator. Such an embodiment has the advantage that the determination of the rotational position can be performed reliably and accurately. In the context of the present invention, the term “intermesh” means that the separating lines between sensor surfaces do not extend radially straight from the center of the stator and/or rotor, but in an undulating, zigzag or other meandering pattern. In other words, the sensor surfaces intermesh with each other in the form of one or more indentations and complementary projections at at least one point along the separating line in order to adapt the coverage profile during a rotation of the rotor.

Also, the conductive section of the rotor may be configured to cover more than one sensor surface of the stator. In other words, the conductive section of the rotor may be configured to cover or overlap at least two sensor surfaces of the stator. Such an embodiment has the advantage that it enables accurate and reliable determination of the rotational position.

Preferably, the conductive section of the rotor is configured to cover at least three sensor surfaces of the stator. This is particularly advantageous because in this constellation, a “middle one” of the three covered sensor surfaces is completely covered, and directly adjacent sensor surfaces are at least partially covered. The signal of this completely covered sensor surface does substantially not change, at least over a certain angular range, when the rotor is rotated because then only the coverage/signal of the surrounding sensor surfaces changes proportionally, while the “middle” sensor surface remains completely covered. This simplifies the determination of the rotor position within this corridor.

Also presented is a method for determining a rotational position of a rotatable element disposed on a device, the device including a stator having a plurality of capacitive sensor surfaces spaced apart from one another in a plane of extension of the stator, and a rotor rotatably disposed relative to the stator and having an electrically conductive section and a dielectric non-conductive section, the conductive section being configured to cover at least two, preferably at least three, sensor surfaces of the stator, and the rotor being disposed opposite the plane of extension of the stator in a rotatable condition relative to the stator, the method including the following steps:

performing a first series of measurements during which an electrical measuring potential is applied to all sensor surfaces of the stator, and reference signals are read from the sensor surfaces in response to the measuring potential, for example, sequentially, although reading in parallel would, in principle, also be possible, the reference signals representing first capacitance values of the sensor surfaces, which are dependent on a position of the rotor;

executing a second series of measurements during which the electrical measuring potential is applied to one sensor surface to be measured among the sensor surfaces and an electrical ground potential is applied to all other sensor surfaces, and during which each of the sensor surfaces is sequentially traversed as a sensor surface to be measured, and measurement signals are read from the sensor surfaces in response to the measuring potential and the ground potential, the measurement signals representing second capacitance values of the sensor surfaces, which are dependent on a position of the rotor;

generating useful signals based on the reference signals and the measurement signals; and

processing the useful signals to determine the rotational position of the rotatable element.

The method may be carried out in connection with or using an embodiment of the device mentioned above. The method may be executable, in particular, by a controller. Advantageously, a rotary position may also be determined without touching or turning the rotatable element. Thus, the proposed capacitive evaluation method, in combination with the device, can enable reliable determination of an absolute rotary position, even after a power-up/restart and without touching the rotatable element. Series of measurements as well as signal processing can be performed without being based on an evaluation method based on a relative change in capacitance, in which sensor surfaces would be initialized in response to a power-up/restart, and their capacitance would be measured, and in which no change in capacitance could be measured at the sensor surfaces without a change in rotational angle or without touching the rotatable element.

In accordance with an embodiment, in the generating step, a difference of the reference signals and the measurement signals may be calculated to generate the useful signals. Such an embodiment has the advantage of making it possible to obtain comparable sensor signals in which interference effects are eliminated. Furthermore, the useful signals may be comparable to previous values, even after a restart of a controller.

Also, in the processing step, the useful signals may be equalized based on at least one ratio between a high point and a low point of a useful signal. A high point may be understood to be a maximum in the signal waveform, and a lowest point may be understood to be a minimum in the signal waveform. Such an embodiment has the advantage of allowing a comparability of the signals, and thus an evaluability, to be improved by such percentage-based equalization.

Further, in the processing step, the useful signals may be normalized and, additionally or alternatively, inverted. Such an embodiment has the advantage of allowing a presentability, and thus an evaluability, of the useful signals to be improved.

In addition, in the processing step, a weighting calculation may be performed on the useful signals. Such an embodiment has the advantage that the determination of the rotational position can be carried out reliably and accurately, allowing signal processing to be performed rapidly and with little computational effort.

The useful signal having the highest signal value may be used as a reference signal for the weighting calculation. Based on a position of the sensor surface associated with the reference signal, a corridor may be determined for the rotational position of the rotatable element. The rotational position of the rotatable element may be determined within the determined corridor based on useful signals from sensor surfaces adjacent the sensor surface that is associated with the reference signal. Also, rotational positions and, additionally or alternatively, corridors may be associated with (detent) positions of the rotatable element. Such an embodiment has the advantage that it enables accurate, absolute and reliable determination of the rotational position or rotational angle.

In accordance with an embodiment, the steps of executing a second series of measurements, of generating useful signals and of processing the useful signals may be repeated, with measurement signals being read only from a few, preferably only one, of the sensor surfaces in the step of executing a second series of measurements. This may preferably be used, for example, in the off or idle state of the household appliance, to monitor the last position of the rotary selector switch that was detected prior to power-off (e.g., the OFF position); i.e., the one or more sensor surfaces associated with this position. It is only when the OFF position or the associated corridor is exited that the monitoring of all sensor surfaces is continued. This makes it possible, in the off/idle state of the device, to monitor the position of the rotary selector switch in a manner that saves power and processing time, while providing very quick response upon power-up/starting of the appliance.

The approach presented here also provides a controller that is adapted for performing, controlling and implementing the steps of a variant of a method presented here in corresponding devices. The object underlying the present invention can also be achieved rapidly and efficiently through this embodiment variant of the present invention in the form of a controller.

The controller may be adapted to read input signals and to determine and provide output signals based on the input signals. An input signal may be, for example, a sensor signal which can be read via an input interface of the controller. An output signal may be a control signal or a data signal which can be provided at an output interface of the controller. The controller may be adapted to determine the output signals using a processing instruction implemented in hardware or software. For this purpose, the controller may, for example, include a logic circuit, an integrated circuit or a software module, and may, for example, be implemented as a discrete device or may be included in a discrete device.

Also presented is a sensor system for detecting a rotational position of a rotatable element, the sensor system including the following features:

an embodiment of the aforementioned device including a stator (250) having a plurality of capacitive sensor surfaces (355) spaced apart from one another in a plane of extension of the stator (250), and a rotor (260) rotatably disposed relative to the stator (250) and having an electrically conductive section (462) and a dielectric non-conductive section (464), the conductive section (462) being configured to cover at least two, preferably at least three, sensor surfaces (355) of the stator (250), the conductive section (462) preferably being larger in area than the non-conductive section (464), and the rotor (260) being disposed opposite the plane of extension of the stator (250) in a rotatable condition relative to the stator (250); and

an embodiment of the aforementioned controller, the controller being connectable or connected to the sensor surfaces of the stator of the device in such a manner that it is capable of transmitting signals.

The rotatable element may be mounted on the fascia panel of a household appliance. Alternatively, the top surface of the rotatable element may be substantially flush with the panel surface, or further alternatively, the rotatable elements may be configured to be partially sunk into the fascia panel.

Thus, an embodiment of the aforementioned device and an embodiment of the aforementioned controller can be advantageously employed or used in the sensor system to detect the rotational position of the rotatable element. The controller may be a microcontroller or the like.

There is further presented a household appliance including the following features:

a control device having a rotatable element, an operator side and an appliance side facing away from the operator side, the rotatable element being disposed on the operator side;

and

an embodiment of the aforementioned sensor system, the rotor of the device of the sensor system being coupled to the rotatable element of the control device, and the stator of the device of the sensor system being disposed on the appliance side of the control device.

The household appliance may, in particular, be in the form of a laundry-treating appliance, such as, for example, a washing machine, a dryer or the like, a food-treating appliance, such as, for example, a microwave oven, a range or a similar appliance, and may also be adapted for commercial or professional use. The rotatable element may be configured as a rotary selector switch or the like. The rotatable element may be rotatable between a plurality of detent positions. The sensor system allows detection of even and odd detent positions, it being possible to implement a number of detent positions twice that of the sensor surfaces provided on the stator. This can allow an arbitrary number of even and odd detent positions of the rotatable element to be sensed with a constant number of sensor surfaces. When changing between two positions, jumps between the positions may be prevented.

In other words, it is possible to sense even and odd detent positions with a constant number of sensor surfaces. With respect to the sensor surfaces, interferences caused, for example, by a centrally disposed ground surface and the supply line thereto may be prevented, and an input of the controller may be dispensed with. During rotation of the rotatable element, jumps between two positions may be prevented. For example, it is also possible to detect intermediate positions. This may be useful to recognize if a detent mechanism got stuck in one position. It is even possible to provide a rotary selector switch which has a large number of sensable positions; i.e., which is virtually or nearly stepless, since when at least three sensor surfaces are provided on the stator, the number of sensable intermediate positions is limited only by the possible resolution of the measurement.

In addition, a duration of a complete measurement and calculation cycle can be optimized or shortened as compared to known solutions, such as the one mentioned above, in which a ground wire is used.

The measurement method allows each sensor surface on the stator to be activated and deactivated, thus allowing individual sensors to be selectively included in, or excluded from, the first and second series of measurements and further calculation. It is possible to deactivate sensor surfaces until only one sensor surface is active for the measurement process, such as, for example, the one with the greatest portion covered by the rotor. This reduces the measurement cycle time and the computational effort of the controller, and ultimately also the power consumption. The reduction in the number of sensor surfaces of the stator that are to be measured may be used to monitor only an arbitrary one of the positions of the rotary selector switch, which, in an exemplary embodiment, may be the OFF position of the household appliance in question. In a practical application, this would preferably be used during standby mode, whereas in operating mode (ON), it is possible to activate sensing of several or all sensor surfaces.

It is also possible to allow the rotatable element to be set to zero in any position or rotational position. This has the advantage of allowing the rotatable element to be mounted in any position, for example during a manufacturing process. Susceptibility to EMC interference (EMC=electromagnetic compatibility) can be reduced or eliminated by the reference measurement or first series of measurements. Since part of the household appliances already have touch controllers, and because of inexpensive system components, it is possible, for example, to implement the presented capacitive determination of rotational angles in a cost-effective manner.

In accordance with an embodiment, the control device may have a continuous dielectric housing portion. At least the device of the sensor system and the rotatable element may be disposed on the housing portion. The housing portion may be in the form of a control panel, switch panel, fascia panel or the like, formed, in particular, of a plastic material. Such an embodiment has the advantage that it can enable rotational position determination through the closed switch panel. For this purpose, a wired rotary selector switch may be constructed without penetrating the control panel by positioning the stator behind the control panel and positioning the rotor on the control panel in the rotary selector switch. Position determination may be based on a capacitive measuring method and may be reliably performed even directly after the controller is started. Thus, suitability exists for household appliances whose operating concept provides for the use of rotary selector switches. Depending on the material of the housing portion (plastic, glass, etc.), it is only necessary to give consideration to a material thickness. A resolution achievable by the sensor system is in particular limited only by signal strengths, regardless, for example, of the number of sensor surfaces.

Also advantageous is a computer program product or computer program having program code which may be stored on a machine-readable carrier or storage medium, such as a semiconductor memory, a hard-disk memory or an optical memory. If the program product or program is executed on a computer or a controller, then the program product or program can be used to perform, implement and/or control the steps of the method in accordance with one of the above-described embodiments.

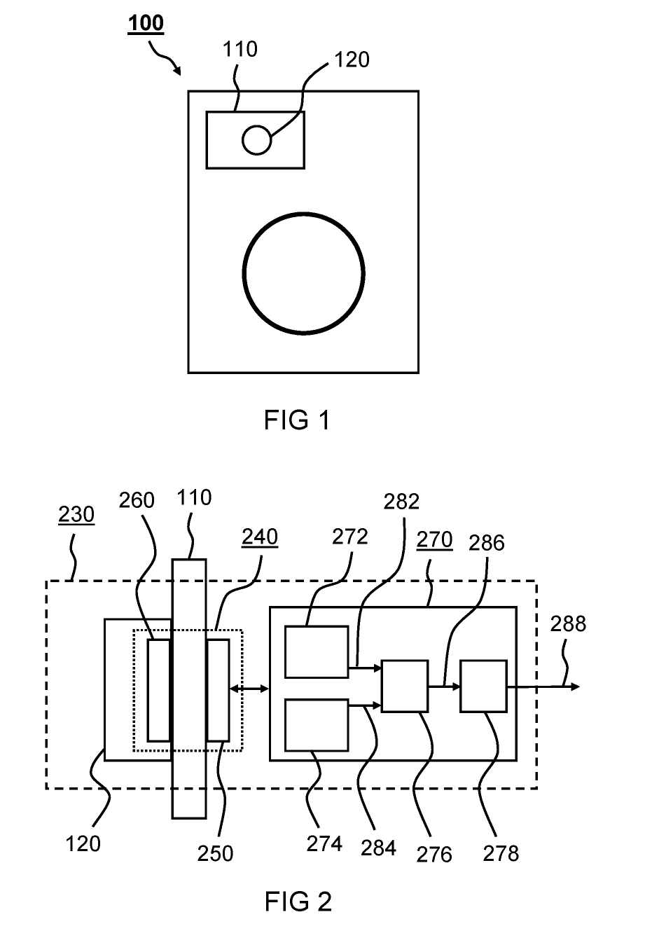

FIG. 1 schematically shows a household appliance 100 according to an exemplary embodiment of the present invention. Merely by way of example, household appliance 100 is here in the form of a washing machine, a laundry dryer, or a combination washer/dryer appliance. Household appliance 100 has a control device 110 having a rotatable element 120.

For reasons of representation, FIG. 1 shows only an operator side of control device 110. The operator side of control device 110 faces a user of household appliance 100 and faces away from an interior of household appliance 100. Control device 110 further has an appliance side, which faces away from the operator side and faces the interior of household appliance 100. Rotatable element 120 is disposed on the operator side of control device 110. Rotatable element 120 is, for example, a rotary selector switch. Rotatable element 120 is rotatable relative to control device 110.

Household appliance 100 further has a sensor system, which is hidden from view in FIG. 1 for reasons of representation. The sensor system will be discussed in more detail below in connection with control device 110 and rotatable element 120.

FIG. 2 schematically shows a sensor system 230 according to an exemplary embodiment of the present invention. Sensor system 230 is disposed on control device 110 and rotatable element 120 of the household appliance of FIG. 1. Alternatively, sensor system 230 may be disposed on a control device and a rotatable element of a similar household appliance. Thus, FIG. 2 shows control device 110, rotatable element 120 and sensor system 230.

Sensor system 230 is configured to detect a rotational position of rotatable element 120. Sensor system 230 has a device 240 for sensing the rotational position of rotatable element 120; i.e., a detecting device 240, and a controller 270 for determining the rotational position of rotatable element 120.

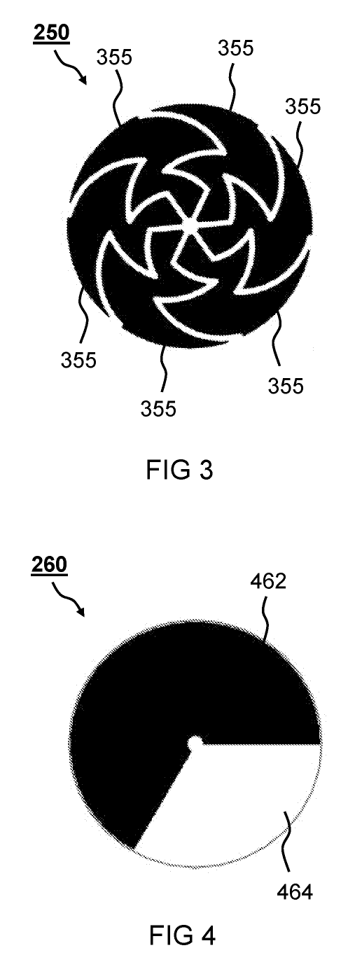

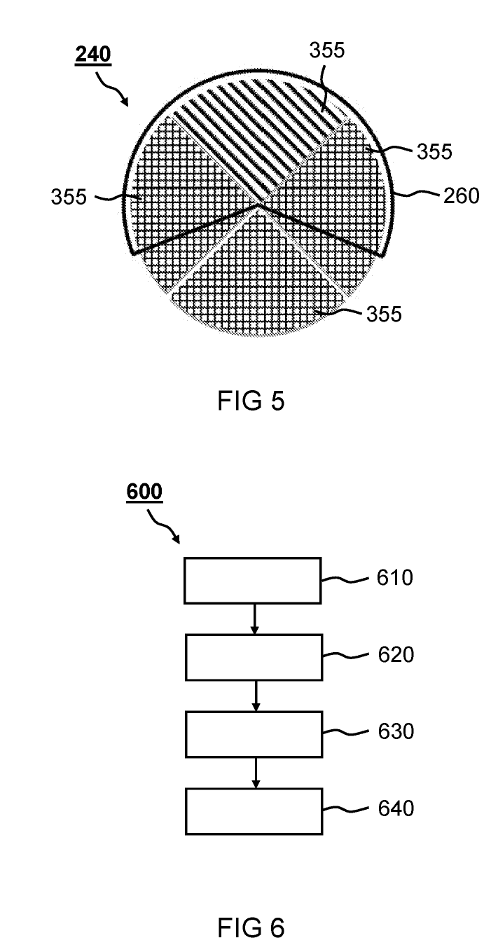

Detecting device 240 has a stator 250 and a rotor 260. Stator 250 may be understood to mean positionally fixed sensor surfaces which are electrically connected to controller or microcontroller 270. Stator 250 has a plurality of capacitive sensor surfaces spaced apart from one another in a plane of extension of stator 250. Stator 250 will be described in greater detail below with reference to FIG. 3 and FIG. 5. Rotor 260 is rotatable relative to stator 250. Rotor 260 has an electrically conductive section and a dielectric non-conductive section. Although not explicitly shown in FIG. 2 for reasons of presentation, the conductive section is larger in area than the non-conductive section of rotor 260. In other words, rotor 260 has a circular copper surface in which a certain angle is left open; i.e., it has a circular segment as a conductive section. The rotor is rotatably supported above the stator, with a dielectric disposed therebetween.

Rotor 260 will be discussed in greater detail below with reference to FIG. 4 and FIG. 5.

Rotor 260 is disposed opposite the plane of extension of the stator. Moreover, rotor 260 is coupled to rotatable element 120. In other words, rotatable element 120 is provided with rotor 260. Stator 250 of detecting device 240 is disposed on the appliance side of control device 110, while rotor 260 and rotatable element 120 are disposed on the operator side of control device 110.

In accordance with the exemplary embodiment of the present invention shown in FIG. 2, control device 110 has a continuous dielectric housing portion or is configured as a continuous dielectric housing portion. In other words, housing portion has no holes therethrough. Detecting device 240 and rotatable element 120 are disposed on the housing portion of control device 110.

Controller 270 is connected to the sensor surfaces of stator 250 of detecting device 240 in such a manner that it is capable of transmitting signals, as symbolized by a double-headed arrow in FIG. 2. Controller 270 is, for example, a microcontroller. Alternatively, controller 270 is configured as part of a microcontroller. Controller 270 has a performing device 272, an executing device 274, a generating device 276 and a processing device 278.

Performing device 272 is configured to perform a first series of measurements. In particular, performing device 272 is configured to apply an electrical measuring potential to all sensor surfaces of the stator and to read reference signals 282 from the sensor surfaces in response to the applied measuring potential, for example, sequentially, although reading in parallel would, in principle, also be possible. Performing device 272 is further configured to output reference signals 282 to generating device 276 or make them available to generating device 276. Reference signals 282 represent first capacitance values of the sensor surfaces of stator 250, which are dependent on a position of rotor 260.

Executing device 274 is configured to execute a second series of measurements. In particular, executing device 274 is configured to apply the electrical measuring potential to one sensor surface to be measured among the sensor surfaces and to apply an electrical ground potential to all other sensor surfaces, to sequentially traverse each of the sensor surfaces as a sensor surface to be measured for the second series of measurements, and to read measurement signals 284 from the sensor surfaces in response to the measuring potential and the ground potential. Executing device 274 is further configured to output measurement signals 284 to generating device 276 or make them available to generating device 276. Measurement signals 284 represent second capacitance values of the sensor surfaces of stator 250, which are dependent on a position of rotor 260.

Generating device 276 is configured to read reference signals 282 and measurement signals 284. Generating device 276 is further configured to then generate useful signals 286 based on reference signals 282 and measurement signal 284. Generating device 276 is also configured to output useful signals 286 to processing device 278 or make them available to processing device 278.

Processing device 278 is configured to read or receive useful signals 286 and process them so as to determine the rotational position of rotatable element 120. Processing device 278 is further configured to provide a position signal 288 representing the determined rotational position of rotatable element 120. In other words, processing device 278 is configured to read useful signals 286 and generate position signal 288 based on useful signals 286.

The measuring potential may also be referred to as shield potential. Sensor surfaces or sensors connected to shield are charged with an image of the sensor surface to be measured or being scanned. A potential difference between the sensor surface to be measured and a sensor surface connected to shield is zero. The ground potential may also be referred to as ground. Sensor surfaces connected to ground are connected directly to the ground potential. A potential difference is detectable between the sensor surface to be measured and the sensor surface connected to ground.

FIG. 3 schematically shows a stator 250 of a device or detecting device according to an exemplary embodiment of the present invention. Stator 250 is, for example, the stator of FIG. 2 or a similar stator. The view of FIG. 3 shows capacitive sensor surfaces 355, which are spaced apart from one another in the plane of extension of stator 250. Merely by way of example, stator 250 has six sensor surfaces 355. In accordance with the exemplary embodiment of the invention shown here, sensor surfaces 355 of stator 250 are configured and/or arranged to intermesh with each other in the plane of extension of stator 250. In other words, the spaces between sensor surfaces 355 exhibit an angular or zigzag pattern. The plane of extension of stator 250 corresponds to the plane of the drawing of FIG. 3.

FIG. 4 schematically shows a rotor 260 of a device or detecting device according to an exemplary embodiment of the present invention. Rotor 260 is, for example, the rotor of FIG. 2 or a similar rotor. The view of FIG. 4 shows electrically conductive section 462 and dielectric non-conductive section 464 of rotor 260. As can be seen, conductive section 462 is larger in area than non-conductive section 464.

FIG. 5 schematically shows a device 240 or detecting device 240 according to an exemplary embodiment of the present invention. Detecting device 240 corresponds or is similar to the detecting device of FIG. 2. Rotor 260 of detecting device 240 corresponds or is similar to the rotor of FIG. 4. For purposes of illustration, only the conductive section of rotor 260 is shown in FIG. 5. Rotor 260 may also be referred to as inverted rotor 260. The stator of detecting device 240 is similar to the stator of FIG. 3; i.e., corresponds to the stator of FIG. 3, except that, for purposes of illustration, FIG. 5 shows only four sensor surfaces 355 of the stator, which do not have an intermeshing configuration.

In FIG. 5, it can be seen that the conductive section of rotor 260 is configured to cover more than one sensor surface 355 of the stator. In accordance with the exemplary embodiment of the present invention shown in FIG. 5, the conductive section of rotor 260 is configured to cover more than two sensor surfaces 355 of the stator. Further, in FIG. 5, a sensor surface 355 to be currently measured is represented by single hatching, while the sensor surfaces 355 surrounding the sensor surface 355 to be measured are represented by cross-hatching.

FIG. 5 illustrates a measuring principle where all sensor surfaces 355 are sequentially or periodically measured for their capacitance. A covered sensor surface 355 is understood to mean a sensor surface 355 of the stator that is covered by the copper surface or the conductive section of rotor 260. An uncovered sensor surface 355 is understood to mean a sensor surface 355 of the stator that is covered by an open area or the non-conductive section of rotor 260; i.e., which is not covered by the copper surface. A sensor surface 355 to be measured or being scanned is understood to mean a sensor surface 355 of the stator that is being measured or scanned by the controller or microcontroller at this point in time. During a complete scanning operation, all sensor surfaces 355 are measured sequentially; i.e., bit by bit. During such a measurement, it can be detected whether a sensor surface 355 is or is not covered by rotor 260. In this connection, a covered sensor surface 355 is referred to as inactive, while an uncovered sensor surface 355 is referred to as active. In the snapshot view of FIG. 5, the measurement would show that the sensor surface to be measured or being scanned is covered by rotor 260, and thus is inactive. In the sequential or periodic capacitance measurement of all sensor surfaces 355, a high capacitance delta means a covered and thus inactive sensor surface 355, while a low capacitance delta means an uncovered and thus active sensor surface 355.

FIG. 6 shows a flow chart of a determination method 600 according to an exemplary embodiment of the present invention. Determination method 600 is executable to determine a rotational position of a rotatable element. The rotatable element is coupled to the rotor of the device of FIG. 2 or FIG. 5, or to that of a similar device. Thus, determination method 600 is executable in connection with the device of FIG. 2 or FIG. 5, or a similar device. Determination method 600 is further executable by or using the controller of FIG. 2 or a similar controller.

Determination method 600 includes a step 610 of performing a first series of measurements, during which an electrical measuring potential is applied to all sensor surfaces of the stator. Also in this step, reference signals are read from the sensor surfaces of the stator in response to the applied measuring potential. The reference signals represent first capacitance values of the sensor surfaces, which are dependent on a position of the rotor.

Determination method 600 further includes a step 620 of executing a second series of measurements. In this step, the electrical measuring potential is applied to one sensor surface to be measured among the sensor surfaces, and an electrical ground potential is applied to all other sensor surfaces. In step 620 of executing the second series of measurements, each of the sensor surfaces is sequentially traversed as a sensor surface to be measured. Then, measurement signals are read from the sensor surfaces in response to the applied measuring potential and the applied ground potential. The measurement signals represent second capacitance values of the sensor surfaces, which are dependent on a position of the rotor.

Following the step 610 of performing the first series of measurements and the step 620 of executing the second series of measurements, useful signals are generated in a generating step 630 based on the reference signals and the measurement signal. In a subsequent processing step 640 of method 600, the useful signals are processed to determine the rotational position of the rotatable element.

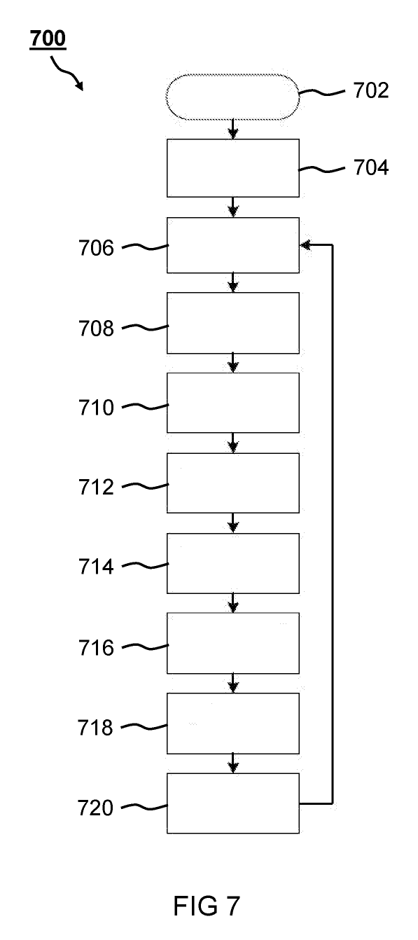

FIG. 7 shows a flow chart of a position determination process 700 according to an exemplary embodiment of the present invention. In other words, FIG. 7 illustrates a program sequence of position determination process 700. Position determination process 700 is executable in connection with the determination method of FIG. 6 or a similar method, and in connection with the sensor system of FIG. 2 or a similar sensor system.

Position determination process 700 starts at a block 702. Then, an initialization is performed at a block 704. Subsequently, at a block 706, all sensor surfaces are set to shield or to the measuring potential. Then, at a block 708, all sensors or sensor surfaces are scanned. Subsequently, in a block 710, a baseline is set to a measured raw count value. Subsequently, in a block 712, all sensor surfaces are set to ground (GND); i.e., to the ground potential. Then, in a block 714, all sensors or sensor surfaces are scanned. In a block 716, the useful signals or signals are then equalized and a separate baseline is calculated. Subsequently, in a block 718, the useful signal or signal is inverted and normalized and/or equalized. Finally, in a block 720, signal evaluation is performed using a weighting calculation. Once the signal evaluation is complete, the program sequence of position determination process 700 may return to block 706.

FIG. 8 shows a schematic signal waveform diagram according to an exemplary embodiment of the present invention. The signal waveform diagram is to be considered in connection with the sensor system of FIG. 2 or a similar sensor system and/or in connection with the determination method of FIG. 6 or a similar method, in particular in connection with the processing device of the controller of the sensor system.

A rotational angle of the rotatable element or rotor relative to the stator of the detecting device of the sensor system is plotted on the axis of abscissas 802 of the signal waveform diagram over a range of 0 to 360 degrees. Signal values are plotted on the axis of ordinates 804 of the signal waveform diagram. In the signal waveform diagram, by way of example, waveforms of only four acquired or generated useful signals 810, 820, 830 and 840 are plotted as a function of the rotational angle.

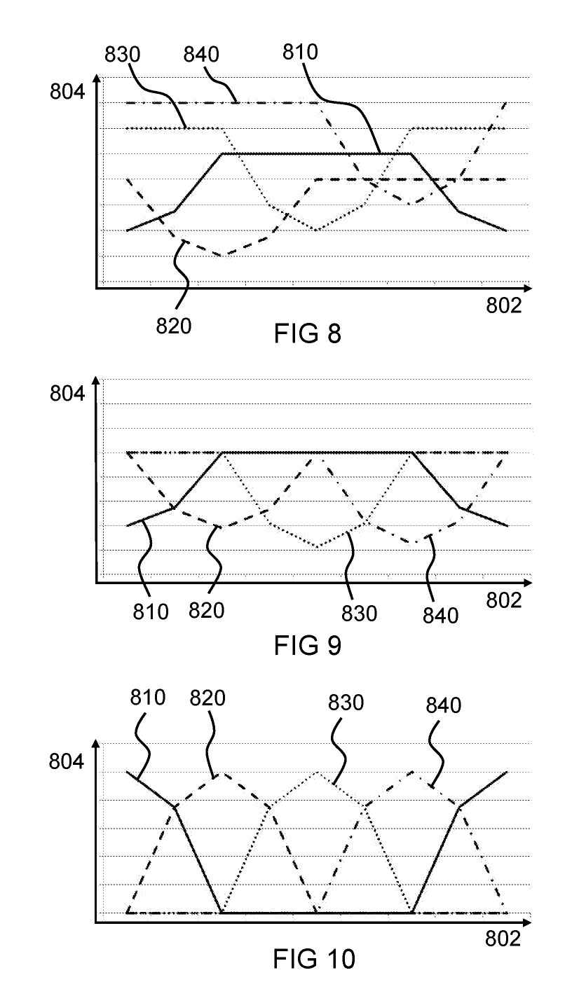

FIG. 9 shows a schematic signal waveform diagram according to an exemplary embodiment of the present invention. The signal waveform diagram shown in FIG. 9 corresponds to that of FIG. 8 with the exception that FIG. 9 shows useful signals 810, 820, 830 and 840 in equalized form.

FIG. 10 shows a schematic signal waveform diagram according to an exemplary embodiment of the present invention. The signal waveform diagram shown in FIG. 10 corresponds to that of FIG. 9, except that in FIG. 10, useful signals 810, 820, 830 and 840 are, in addition, shown in normalized and inverted form.

With reference to FIGS. 1 through 10, exemplary embodiments of the present invention will hereinafter be described in summary and/or explained once again using different words. Important aspects of exemplary embodiments include a geometry of rotor 260 and stator 250, as well as a sequence of method 600 with respect to the measurement and evaluation of capacitances.

A potential difference necessary for such a measurement is coupled in via rotor 260; i.e., via its conductive section 462, which couples the potential difference in via the sensor surfaces 355 that are adjacent a sensor surface 355 being measured, as shown in FIG. 5. To this end, sensor surfaces 355 may be configured for the unscanned state, for example, in a software of controller or microcontroller 270. In such a measurement method, there is provided a rotor 260 having a conductive section 462 or an electrically conductive surface of at least two sensor surfaces 355. Thus, a useful signal 286, or 810, 820, 830 or 840, respectively, does not experience a low point while a sensor surface 355 is being traversed, because no reduction occurs in the coupled-in area of the surrounding sensor surfaces 355, and a high raw value can be obtained using such an inverted rotor 260, such as is shown in FIG. 4. In an inverted rotor 260, conductive section 462 (i.e., the copper surface) and non-conductive section 464 (i.e., the open area) of rotor 260 are interchanged, as compared with a conventional rotor. An inverted rotor 260 features a conductive section 462 that occupies more than 180 degrees of rotor 260. In an inverted rotor 260, an active sensor surface 355 is not covered and an inactive sensor surface 355 is covered by conductive section 462. For this reason, useful signals 286, or 810, 820, 830 or 840, respectively, are inverted computationally.

In order to computationally remove environmental influences and interferences and to maintain operation after a restart of sensor system 230, the first series of measurements is performed as a reference measurement. This is done by a performing a measurement with the surrounding sensor surfaces 355 configured to shield. In this measurement, the surrounding sensor surfaces 355 are charged to the potential of the sensor surface 355 to be measured, and thus a rotor 260 which is coupled-in and one which is not coupled-in will measure nearly the same raw value across all sensor surfaces 355. The first series of measurements serves as a reference. Subsequent to the first series of measurements or measurement with the surrounding sensor surfaces 355 configured to shield, the second series of measurements is performed with the surrounding sensor surfaces 355 configured to ground. The difference between the measurement at ground and the measurement at shield represents the useful signal 286, or 810, 820, 830 or 840, respectively, as shown in FIG. 8. To be able to compare useful signals 286, or 810, 820, 830 and 840, respectively, to each other, the ratios of useful signal 286, or 810, 820, 830 or 840, respectively, relative to one another are included and designated as rotational angle sensor parameters. These ratios are used to equalize useful signals 286, or 810, 820, 830 and 840, respectively, based on percentages, as shown in FIG. 9. Because of inverted rotor 260, useful signals 286, or 810, 820, 830 and 840, respectively, are inverted and, for the sake of better illustration, normalized via the ratio between active and inactive sensor surfaces 355, for example, to many, for example 1000, values, as shown in FIG. 10.

For purposes of determining the rotational or angular position, the equalized and inverted useful signals 286, or 810, 820, 830 and 840, respectively, are converted to a defined resolution by the weighting calculation. For the weighting calculation, it is desired, for example, that intersection points between rising and falling useful signals 286, or 810, 820, 830 and 840, respectively, are located at about 75 percent of a maximum signal value. For this reason, sensor surfaces 355 intermesh with each other, as shown in FIG. 3, whereby each individual sensor surface 355 is covered earlier by rotor 260 as the rotor is rotated thereover, thus raising the intersection point of falling and decreasing useful signals 286, or 810, 820, 830 and 840, respectively.

For a more accurate position determination, corridors are defined within the weighted value for a position. If the value of a useful signal 286, or 810, 820, 830 or 840, respectively, is within such a corridor, then an associated detent position of rotatable element 120 is recognized. If the value is outside the corridor, the previous position is maintained. This prevents jumping between two positions.

In other words, in order to detect the rotational position, it is necessary to measure the capacitance of each sensor surface 355. Two extreme cases can be distinguished: a covered, scanned sensor surface 355 on the one hand, and an uncovered, scanned sensor surface 355 on the other hand. In the case of the covered sensor surface 355, a potential difference can be coupled in via rotor 260. Thus, a higher capacitance is measured compared to an uncovered sensor surface 355.

In order for determination method 600 or the measurement method to be absolute and independent of external interference effects, the first series of measurements; i.e., a reference measurement of an individual sensor surface 355, is performed with the surrounding sensor surfaces 355 configured to shield. In this configuration, a low capacitance is measured because all sensor surfaces 355 are at the same potential and, therefore, cannot be coupled in via rotor 260. Thus, the measurement of all sensor surfaces 355 (regardless of whether covered or uncovered) may yield a similar measurement value temporally and between the sensor surfaces 355. The first series of measurements (i.e., a reference measurement) is performed with each individual sensor surface 355 of stator 250 prior to executing the second series of measurements or a further measurement. The measurement values are stored, for example, in an array in a program of controller 270.

Despite the efforts to make the individual sensor surfaces 355 as equal as possible, differences may occur, which may affect the useful signals 286, or 810, 820, 830 and 840, respectively, of the individual sensor surfaces 355. To nevertheless be able to compare useful signals 286, or 810, 820, 830 and 840, respectively, relativities have been included. To this end, for example, a ratio of a maximum signal value of a sensor surface to a maximum signal value of a reference sensor was included. A reference sensor may be any of the sensor surfaces 355 disposed on stator 250. This relativities are used to equalize useful signals 286, or 810, 820, 830 and 840, respectively.

After the first series of measurements, or reference measurement, all sensor surfaces 355 are scanned once again. During this, the potential of the sensor surfaces 355 surrounding a respective sensor surface 355 being scanned is at ground. In the second series of measurements, a high capacitance is measured for a covered sensor surface 355, and a low capacitance is measured for an uncovered sensor surface 355. The measured capacitance is stored, for example, in another array in the program of controller 270.

A difference is calculated from the series of measurements; i.e., from the reference measurement, and the ground measurement, and thus the individual sensor signals are comparable to each other. In addition, this calculation eliminates interference effects (caused, for example, by a hand). Moreover, the reference measurement actually performed in the first series of measurements allows useful signals 286, or 810, 820, 830 and 840, respectively, to remain comparable to previous values, even after a restart of controller 270.

Through the use of inverted rotor 260, useful signals 286, or 810, 820, 830 and 840, respectively, of sensor surfaces 355 are then inverted to be able to perform an equilibrium calculation. In addition, the signal level of each useful signal 286, or 810, 820, 830 and 840, respectively, is not fully identical to the other sensors, so that an additional ratio is included which describes a percentage ratio between a high point and a low point of a useful signals 286, or 810, 820, 830 or 840, respectively. Both operations (inversion and normalization) are performed, for example, in processing step 640. Normalized and inverted useful signals 286, or 810, 820, 830 and 840, respectively, are shown, for example, in FIG. 10.

At a preliminary stage, a resolution is defined for rotatable element 120 or the rotary selector switch. The position or rotational position can then be calculated, within the resolution, from the normalized and inverted useful signals 286, or 810, 820, 830 and 840, respectively, using the weighting calculation. In order to define the resolution, the level of useful signals 286, or 810, 820, 830 and 840, respectively, is considered at a preliminary stage. Moreover, an intersection point of two signals may be located at 75 percent of the maximum signal. The weighting calculation considers the sensor surface 355 having the greatest signal. Since the arrangement of the sensor surfaces on stator 250 is known, a corridor of the rotational position may already be determined via the highest signal of useful signals 286, or 810, 820, 830 and 840, respectively. Subsequently, the rotational position can be inferred more accurately via the sensor surfaces 355 adjacent the sensor surface 355 having the highest signal.

The rotational position calculated from the equilibrating calculation is then converted to the desired number of positions. The desired number of positions is calculated using, for example, a divisor and a modulo operator. To this end, initially, a corridor is defined in which each rotational position or detent position is located. The use of a corridor has the advantage that the position is reliably detected and does not jump. The corridors also make it possible to detect whether a detent mechanism is located, and thus stuck, between two positions. A number of detent position of rotatable element 120 is selectable within the resolution within wide limits or almost freely.

The position, rotational position or detent position of rotatable element 120 or of the rotary selector switch is known at this point and can be further processed by controller 270 or. Thereafter, the program sequence for capacitance-based contactless and absolute determination of rotational angles restarts from the beginning with performing the first series of measurements on sensor surfaces 355, as shown, for example, in FIG. 7.

By converting the resolution to detent positions of rotatable element 120, it is further possible to freely select an initial detent position on rotatable element 120 or the rotary selector switch at any time during, for example, the development or manufacture, or after delivery.

Based on useful signals 286, or 810, 820, 830 and 840, respectively, a weighting calculation function of controller 270 may calculate, for example, a so-called radial slider having a defined resolution. The individual desired detent positions may be calculated from this resolution. This is possible within a range of, merely by way of example, 2 to 13 detent positions using the existing sensor surfaces 355. This does not require any change in hardware, but only an adaptation of the software. Advantageously, it is only necessary to configure the sensors and, in a manufacturing process, it is only required to install the appropriate detent mechanism.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A device for sensing a rotational position of a rotatable element for a household appliance, the device comprising:
a stator having a plurality of capacitive sensor surfaces spaced apart from one another in a plane of extension of the stator; and
a rotor rotatably positionable or disposed relative to the stator and having an electrically conductive section and a dielectric non-conductive section, the conductive section being larger in area than the non-conductive section, the rotor being disposed opposite the plane of extension of the stator in a rotatable condition relative to the stator, and the rotor being couplable or coupled to the rotatable element.

2. The device as recited in claim 1, wherein the sensor surfaces are configured and/or arranged to intermesh with each other in the plane of extension of the stator.

3. The device as recited in claim 1, wherein the conductive section of the rotor is configured to cover more than one sensor surface of the stator.

4. A method for determining a rotational position of a rotatable element for a household appliance, the rotatable element being disposed on a device, the device including a stator having a plurality of capacitive sensor surfaces spaced apart from one another in a plane of extension of the stator, and a rotor rotatably disposed relative to the stator and having an electrically conductive section and a dielectric non-conductive section, the conductive section being configured to cover at least two, preferably at least three, sensor surfaces of the stator, and the rotor being disposed opposite the plane of extension of the stator in a rotatable condition relative to the stator, the method comprising the following steps:
performing a first series of measurements during which an electrical measuring potential is applied to all sensor surfaces of the stator, and reference signals are read from the sensor surfaces in response to the measuring potential, the reference signals representing first capacitance values of the sensor surfaces, which are dependent on a position of the rotor;
executing a second series of measurements during which the electrical measuring potential is applied to one sensor surface to be measured among the sensor surfaces, and an electrical ground potential is applied to all other sensor surfaces, and during which each of the sensor surfaces is traversed as a sensor surface to be measured, and measurement signals are read from the sensor surfaces in response to the measuring potential and the ground potential, the measurement signals representing second capacitance values of the sensor surfaces, which are dependent on a position of the rotor;
generating useful signals based on the reference signals and the measurement signals; and
processing the useful signals to determine the rotational position of the rotatable element.

5. The method as recited in claim 4, wherein, in the generating step, a difference of the reference signals and the measurement signals is calculated to generate the useful signals.

6. The method as recited in claim 4, wherein, in the processing step, the useful signals are equalized based on at least one ratio between a high point and a low point of a useful signal.

7. The method as recited in claim 4, wherein, in the processing step, the useful signals are normalized and/or inverted.

8. The method as recited in claim 4, wherein, in the processing step, a weighting calculation is performed on the useful signals.

9. The method as recited in claim 8, wherein the useful signal having the highest signal value is used as a reference signal for the weighting calculation; a corridor being determined for the rotational position of the rotatable element based on a position of the sensor surface associated with the reference signal; the rotational position of the rotatable element being determined within the determined corridor based on useful signals from sensor surfaces adjacent the sensor surface that is associated with the reference signal.

10. The method as recited in claim 4, the method further comprising the following step:
repeating the steps of executing a second series of measurements, of generating useful signals and of processing the useful signals, with measurement signals being read only from a few of the sensor surfaces in the step of executing a second series of measurements.

11. A controller adapted to perform the steps of the method according to claim 4.

12. A sensor system for detecting a rotational position of a rotatable element for a household appliance, the sensor system comprising:
a device including a stator having a plurality of capacitive sensor surfaces spaced apart from one another in a plane of extension of the stator, and a rotor rotatably disposed relative to the stator and having an electrically conductive section and a dielectric non-conductive section, the conductive section being configured to cover at least two, preferably at least three, sensor surfaces of the stator, the conductive section being larger in area than the non-conductive section, and the rotor being disposed opposite the plane of extension of the stator in a rotatable condition relative to the stator; and
a controller adapted to perform a method for determining the rotational position of the rotatable element, the controller being connectable or connected to the sensor surfaces of the stator of the device such that it is capable of transmitting signals, the method including the following steps:
performing a first series of measurements during which an electrical measuring potential is applied to all sensor surfaces of the stator, and reference signals are read from the sensor surfaces in response to the measuring potential, the reference signals representing first capacitance values of the sensor surfaces, which are dependent on a position of the rotor;
executing a second series of measurements during which the electrical measuring potential is applied to one sensor surface to be measured among the sensor surfaces, and an electrical ground potential is applied to all other sensor surfaces, and during which each of the sensor surfaces is traversed as a sensor surface to be measured, and measurement signals are read from the sensor surfaces in response to the measuring potential and the ground potential, the measurement signals representing second capacitance values of the sensor surfaces, which are dependent on a position of the rotor;
generating useful signals based on the reference signals and the measurement signals; and
processing the useful signals to determine the rotational position of the rotatable element.

13. A household appliance comprising:
a control device having a rotatable element, an operator side, and an appliance side facing away from the operator side, the rotatable element being disposed on the operator side; and
the sensor system according to claim 12, the rotor of the device of the sensor system being coupled to the rotatable element of the control device, and the stator of the device of the sensor system being disposed on the appliance side of the control device.

14. The household appliance as recited in claim 13, wherein the control device has a continuous dielectric housing portion; at least the device of the sensor system and the rotatable element being disposed on the housing portion.

15. A computer program product comprising program code for performing the method according to claim 4 when the computer program product is executed on a controller.

16. The device as recited in claim 3, wherein the conductive section of the rotor is configured to cover at least two sensor surfaces of the stator.

17. The device as recited in claim 16, wherein the conductive section of the rotor is configured to cover at least three sensor surfaces of the stator.
